(19) United States
(12) Patent Application Publication
(10) Pub. No.: US 2022/0387831 A1
(43) Pub. Date: Dec. 8, 2022

(54) Universal flame arrester ember catcher

(71) Applicant: James E. Pearson, Los Angeles, CA (US)

(72) Inventor: James E. Pearson, Los Angeles, CA (US)

(21) Appl. No.: 16/974,261

(22) Filed: Nov. 28, 2020

(51) Int. Cl. A62C 2/06

(52) U.S. Cl. CPC A62C 2/06

(57) ABSTRACT

A Ember Catcher for wild fire protection comprised of: Layers of steel flame arrester screen sheets. Fasten together with flame resistant fasteners. And joined together to form large Tarps.

### SUMMERY OF INVENTION

Accordingly, It is an object of the present invention to provide a Ember Catcher which is capable of overcoming the above described problem.

To this end according to the present invention provide a Ember Catcher comprised: of Layered Sheet of Steel Flame Arrester. Fasten together with Flame resistant fasteners. The Layered sheet are then fasten together End to End with the Fasteners to form large Tarps. These Tarps can be used the completely cover personal property and prevent it from catching on fire.

### BRIEF DISCRIPTION OF DRAWINGS

FIG. 1. Expanded view illustrating an Ember Catcher according to the present invention.

FIG. 2. Cross Sectional view of FIG. 1 including (3) Flame resistant fasteners.

FIG. 3. Cross Sectional view of FIG. 1 Fasten together by Flame Resistant fasteners.

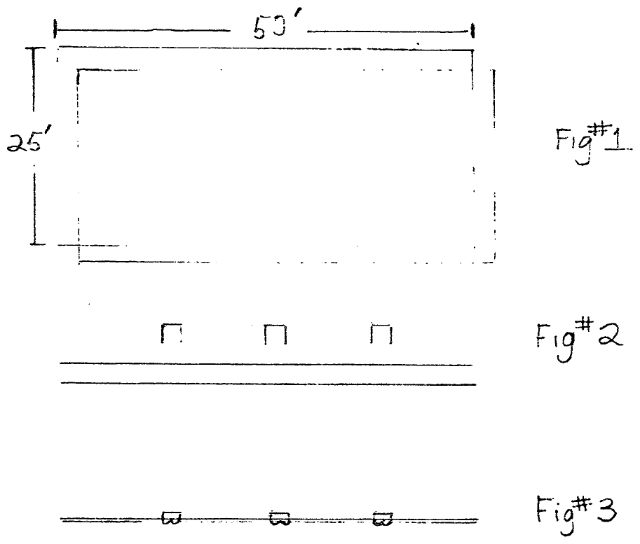

### UNIVERSAL FLAME ARRESTER EMBER CATCHER

1. Circumstance of Conception: California Wild Fire's.

2. Purpose and Advantages of invention: The Purpose of this invention is to stop Houses and Properties from catching on fire during a Forest Fire. The Advantages are when properly installed it stops Embers from catching Houses, Sheads, Cars etc on fire. It stops ember from landing on Roofs and surrounding area.

3. Description: Made from Large Sheet's of Steel Screen Flame Arrester Mesh. Uses to cover Roof Tops, Vehicles, Sheads, etc. It can be made into 25′×25′ or larger Tarps. These Tarp can be used like an Extermination Tent to completely cover a house and protect it from flames and embers.

5. The Ramifications: Ramification for this invention is the California Wild Fires. California Wild Fires are burning forest and homes.

This invention was created to help stop homes and properties from burning.

As a consequence of this happening I James E Pearson invented Ember Catching Tarp.

6. Novel Feature: Unlike chemical flame retardent. Ember Catcher Tarp can be easily removed after applied.

7. Closes known Prior Art: After researching I found (3)

1: Chiminea Ember Blocker Screen metal spark stopper filter 11″ Dia

2: Ember Out Products U.S. Pat. No. 9,822,532.

3: Brandguard Vent Foundation Back Flange. Patent Pending
Built from Layers of Stainless Steel screen mesh.

Upon testing of the prototype No Ember or Flame burnt through.

What I claim is:

1. A Ember Catcher Comprised of Layers of Steel Flame Arrester screen sheets. Said sheets are secured together with Flame Resistant Fasteners. Said Layered Sheets are secured together End to End using Said Flame Resistant Fasteners forming large Tarps.
